(19) United States
(12) Patent Application Publication
(10) Pub. No.: US 2007/0285239 A1
(43) Pub. Date: Dec. 13, 2007

(54) Centralized optical-fiber-based RFID systems and methods

(76) Inventors: Martyn N. Easton, Lenoir, NC (US); Michael Sauer, Corning, NY (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/451,237

(22) Filed: Jun. 12, 2006

(51) Int. Cl. G08B 13/14

(52) U.S. Cl. 340/572.1

(57) ABSTRACT

The optical-fiber-based radio-frequency identification (RFID) system includes one or multiple RFID readers optically coupled to one or more transponders via respective one or more optical fiber RF communication links. The transponders are each adapted to receive electromagnetic RF tag signals from RFID tags within the associated picocell and transmit optical RF tag signals to the corresponding RFID reader over the corresponding optical fiber RF communication link. The RFID reader then converts the optical RF tag signals to electrical RFID tag signals, and extracts the RFID tag information from the RFID tag signals. The transponders can be arranged spaced apart along the length of one or more optical fiber cables made up of pairs of downlink and uplink optical fibers that constitute the optical fiber RF communication links.

### FIELD OF THE INVENTION

The present invention relates generally to radio-frequency identification (RFID) systems, and in particular relates to centralized RFID systems and methods employing RF transmission over optical fiber.

### BACKGROUND OF THE INVENTION

### I. Wireless Picocellular Systems

Wireless communication is rapidly growing, with ever-increasing demands for high-speed mobile data communication. As an example, so-called “wireless fidelity” or “WiFi” systems and wireless local area networks (WLANs) are being deployed in many different types of areas (coffee shops, airports, libraries, etc.). Wireless communication systems communicate with wireless devices called “clients,” which must reside within the wireless range or “cell coverage area” in order to communicate with the access point device.

One approach to deploying a wireless communication system involves the use of “picocells,” which are radio-frequency (RF) coverage areas having a radius in the range from about a few meters up to about 20 meters. Because a picocell covers a small area, there are typically only a few users (clients) per picocell. Picocells also allow for selective wireless coverage in small regions that otherwise would have poor signal strength when covered by larger cells created by conventional base stations.

Picocells are created by and centered on a wireless access point device connected to a head-end controller. A wireless access point device includes a RF transmitter/receiver operably connected to an antenna, and digital information processing electronics. The size of a given picocell is determined by the amount of RF power transmitted by the access point device, the receiver sensitivity, antenna gain and the RF environment, as well as by the RF transmitter/receiver sensitivity of the wireless client device. Client devices usually have a fixed RF receive sensitivity, so that the above-mentioned properties of the access point device largely determine the picocell size.

Connecting a number of access point devices to the head-end controller creates an array of picocells that cover an area called a “picocellular coverage area.” A closely packed picocellular array provides high-data-throughput over the picocellular coverage area.

### II. Radio-Frequency Identification

Radio-frequency identification (RFID) is a remote recognition technique that utilizes RFID tags having information stored therein. The stored information is retrievable via RF communication between the RFID tag and a RFID tag reader. The typical RFID system utilizes one or more hand-held RFID readers that when brought sufficiently close to a RFID tag are able to read a RFID tag signal emitted by the tag. RFID systems are used for inventory management and product tracking in a variety of different industries, as well as in libraries and hospitals.

There are three main types of RFID tags. The first type is a passive RFID tag that has a microcircuit (typically, a digital memory chip) with no internal power supply. A passive RFID tag is powered by an incoming RF signal from the RFID tag reader. The RF signal provides enough power for the microcircuit to transmit the information stored in the RFID tag to the RFID reader via an electromagnetic RF tag signal.

The second type of RFID tag is semi-passive, and includes a microchip plus a small power supply so that RFID tag can generate a stronger RF tag signal, leading to a greater read range. The third type of RFID tag is active and, like the semi-passive type tag, has its own power supply. Active RFID tags generate an outgoing RF tag signal and can respond to RF signal queries from the RF tag reader, or periodically generate their own outgoing RF tag signal.

Implementing a RFID system that covers a relatively large area (e.g., an entire warehouse) and that tracks many items with high-resolution requires in one application deploying a large number of RFID tag readers. Further, the RFID tag readers require connection to a central computer that can process the data received from the RFID tags.

In another conventional RFID application that seeks to reduce the number of RFID tag reads, people physically carry RFID tag readers over the premises and interrogate each RFID tag, which typically has a short read range, e.g., one meter or less. This conventional approach to RFID is still equipment-intensive and is also labor-intensive, and tends to be expensive to implement and maintain.

### SUMMARY OF THE INVENTION

One aspect of the invention is an optical-fiber-based RFID system for tracking one or more RFID tags each having information stored therein. The system includes a picocellular coverage area made up of an array of one or more picocells. The picocells are formed by corresponding one or more transponders. Each transponder has an antenna and each is adapted to convert electrical RF signals to optical RF signals and vice versa. The system also includes one or multiple RFID readers. Each RFID reader is optically coupled to the one or more transponders via corresponding one or more optical fiber RF communication links. Each transponder is optically coupled to one of the one or multiple RFID readers. Each transponder is adapted to receive and relay information stored in each RFID tag located within the corresponding picocell to the corresponding RFID reader over the corresponding optical fiber RF communication link.

Another aspect of the invention is an optical-fiber-based RFID system for tracking one or more RFID tags that emit electromagnetic RFID tag signals. The system includes one or more RFID readers, and one or more transponders. Each transponder is adapted to convert optical RF signals to electromagnetic RF signals and vice versa over a picocell formed by the corresponding transponder. The system also includes one or more optical fiber RF communication links that optically couple each of the one or more transponders to the one or more RFID readers. In one example, the optical fiber RF communication links each include a downlink optical fiber and an uplink optical fiber. In operation, the one or more RFID readers address the one or more transponders by sending RF interrogation signals to one or more transponders over the one or more optical fiber RF communication links. This causes the addressed transponders to electromagnetically interrogate RFID tags within a given picocell, and relay RFID tag information emitted by the RFID tags over the optical communication link back to the corresponding RFID reader. The RFID tag information can optionally be stored in the RFID readers, in an external database storage unit, or passed along to an outside network.

Another aspect of the invention is a RFID method that includes locating one or more RFID tags having information stored therein within a picocellular coverage area made up of one or more picocells formed by corresponding one or more transponders. The method also includes sending an interrogation signal from a RFID reader to each transponder over a corresponding optical fiber in order to elicit RFID tag signals from any RFID tags located in the corresponding transponder picocell. The method further includes detecting, in the corresponding transponder, electromagnetic RFID tag signals emitted within each picocell by RFID tags therein, and

transmitting the received RFID tag signals to the corresponding RFID tag reader over an optical fiber.

Additional features and advantages of the invention are set forth in the detailed description that follows, and will be readily apparent to those skilled in the art from that description or recognized by practicing the invention as described herein, including the detailed description that follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

Accordingly, various basic electronic circuit elements and signal-conditioning components, such as bias tees, RF filters, amplifiers, power dividers, etc., are not all shown in the Figures for ease of explanation and illustration. The application of such basic electronic circuit elements and components to the RFID system of the present invention will be apparent to one skilled in the art.

### BRIEF DESCRIPTION OF THE DRAWINGS

FIG. 1 is a schematic diagram of a generalized embodiment of an optical-fiber-based RFID system according to the present invention;

FIG. 2 is a detailed schematic diagram of an example embodiment of the RFID system of FIG. 1;

FIG. 3 is a close-up view of an alternative example embodiment for the transponder of the RFID system of FIG. 2, wherein the transponder includes a transmitting antenna and a receiving antenna;

FIG. 4 is a schematic diagram of an example embodiment of an optical-fiber-based RFID system according to the present invention that utilizes a plurality of RFID readers in combination with a corresponding plurality of spaced-apart transponders arranged in an optical fiber cable;

FIG. 5 is a close-up schematic lengthwise cross-sectional view of a section of the optical fiber cable of the RFID system of FIG. 4, showing the individual downlink and uplink optical fibers, the electrical power line, and the spaced-apart transponders;

FIG. 6 is a schematic diagram of an example embodiment of an optical-fiber-based RFID system according to the present invention that utilizes an optical switch to optically couple a single RFID reader to two or more transponders in an optical fiber cable;

FIG. 7 is a close-up view of the RFID system of FIG. 6, showing details of an example embodiment of an optical switch that employs an adjustable mirror, and illustrating the various downlink and uplink optical fibers at the two I/O ports of the optical switch;

FIG. 8 is a schematic diagram of an example embodiment of an optical-fiber-based RFID system according to the present invention that utilizes a single RFID reader having a plurality of “converter pairs” each made up of an E/O converter and an O/E converter, with each converter pair optically coupled to a transponder arranged in an optical fiber cable;

FIG. 9 is a schematic diagram of an example embodiment of an optical-fiber-based-RFID system according to the present invention that employs a number of the RFID systems of FIG. 4 to create an extended picocellular coverage area through the use of multiple optical fiber cables;

FIG. 10 is a schematic “top-down view” of the RFID system of FIG. 9, illustrating the extended picocell coverage area;

FIG. 11 is a schematic “side-view” of the RFID system of FIG. 9, illustrating the picocell coverage area associated with a single optical fiber cable;

FIG. 12 is a close-up view of a section of optical fiber cable of the RFID system of FIG. 9, showing a single transponder and the corresponding picocell, illustrating the electromagnetic interrogation of RFID tags within the picocell, and the electromagnetic RFID tag signal response from the RFID tags.

### DETAILED DESCRIPTION OF THE PREFERRED EMBODIMENTS

Reference is now made in detail to the present preferred embodiments of the invention, examples of which are illustrated in the accompanying drawings. Whenever possible, the same or analogous reference numbers are used throughout the drawings to refer to the same or like parts.

### I. Basic Optical-Fiber-Based RFID System

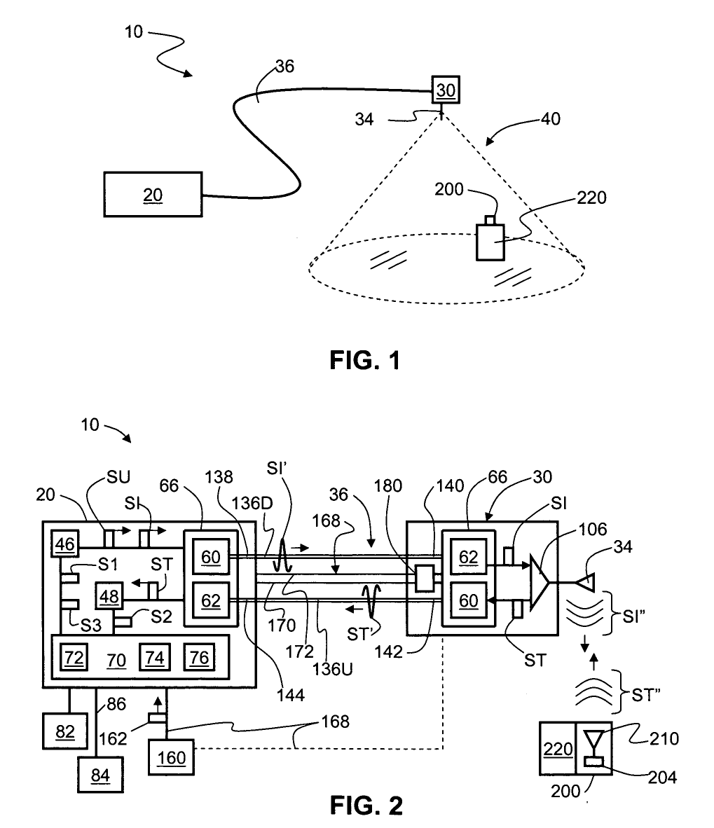

FIG. 1 is a schematic diagram of a generalized embodiment of an optical-fiber-based RFID system 10 according to the present invention. System 10 includes a RFID reader unit (“RFID reader”) 20, a transponder unit (“transponder”) 30 that includes an antenna 34, and an optical fiber RF communication link 36 that optically couples the RFID reader to the transponder. As discussed below, RFID system 10 has picocell 40 substantially centered about antenna 34. The discussion below is assumes for the sake of illustration that antenna 34 is located in close proximity to the other components making up transponder 30 so that the location picocell 40 is said to correspond to the location of the transponder as a whole. In practice, however, one skilled in the art will understand that antenna 34 may be located sufficiently far away from the other transponder components so that the location of picocell 40 is best described relative to the antenna per se.

FIG. 2 is a detailed schematic diagram of an example embodiment of the RFID system 10 of FIG. 1. In an example embodiment, RFID reader 20 includes a RF signal modulator 46 electrically coupled to an electrical-to-optical (E/O) converter 60, which is adapted to receive an electrical signal and convert it to an optical signal. In an example embodiment, E/O converter 60 includes a laser suitable for delivering sufficient dynamic range for this RF-over-fiber application, and also optionally includes a laser driver/amplifier electrically coupled to the laser. Examples of suitable lasers for E/O converter 60 include laser diodes, distributed feedback (DFB) lasers, Fabry-Perot (FP) lasers, and vertical cavity surface emitting lasers (VCSELs).

RFID reader 20 also includes a RF signal demodulator 48 electrically coupled to an optical-to-electrical (O/E) converter 62, which is adapted to receive an optical signal and convert it to an electrical signal. In an example embodiment, O/E converter is a photodetector, or a photodetector electrically coupled to a linear amplifier. E/O converter 60 and O/E converter 62 constitute a “converter pair” 66.

RFID reader 20 further includes a control unit (“controller”) 70 electrically coupled to RF signal modulator 46 and RF signal demodulator 48. In an example embodiment, controller 70 includes a digital signal processing unit (“digital signal processor”) 72, a central processing unit (CPU) 74 for processing data and otherwise performing logic and computing operations, and a memory unit 76 for storing data, such as RFID tag information obtained as described below. In an example embodiment, data is stored in an external data storage unit 82 operably coupled to RFID reader 20 and in particular to controller 70 therein. In an example embodiment, controller 70 is operably coupled to an outside network 84 via a network link 86.

With continuing reference to FIG. 2, transponder 30 includes a converter pair 66 electrically coupled to antenna 34 via a RF signal-directing element 106, such as a circulator or RF switch. Signal-directing element 106 serves to direct downlink RF interrogation signals and uplink RF tag signals, as discussed below.

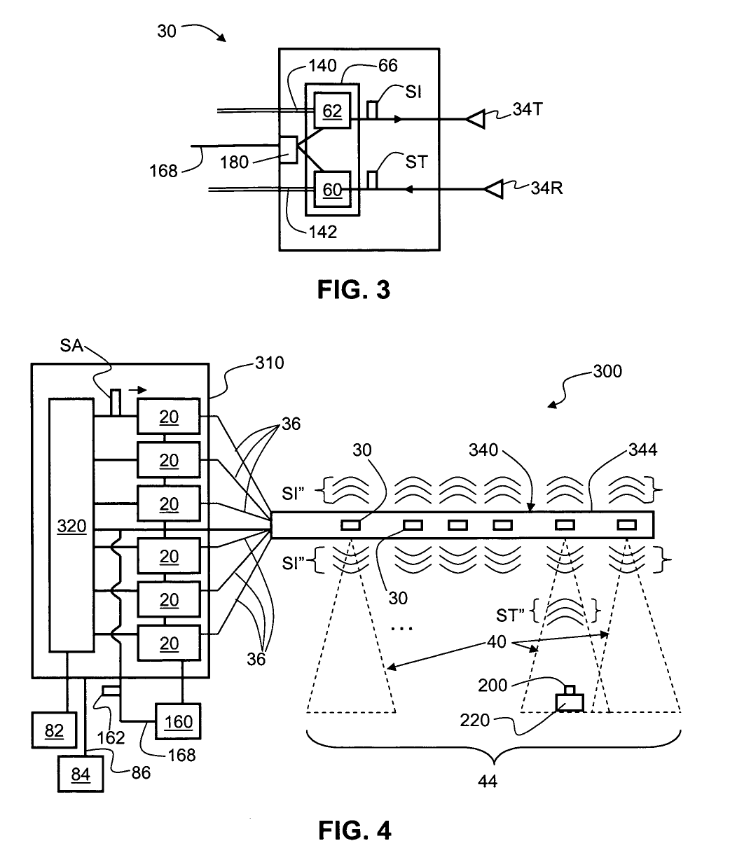

FIG. 3 is a close-up view of an alternative example embodiment for transponder 30 that includes two antennae 34: a transmitting antenna 34T electrically coupled to O/E converter 62, and a receiving antenna 34R electrically coupled to O/E converter 60. The two-antenna embodiment obviates the need for RF signal-directing element 106.

Transponders 30 of the present invention differ from the typical access point device associated with wireless communication systems in that the preferred embodiment of the transponder has just a few signal conditioning elements and no digital information processing capability. Rather, the digital information processing capability is located remotely at RFID reader 20, and in a particular example in controller 70. This allows transponder 30 to be very compact, virtually maintenance free. Further, the transponders need not be altered when performing system upgrades. In addition, transponder 30 consumes very little power, and does not require a local power source, as described below.

With reference again to FIG. 2, an example embodiment of optical fiber RF communication link 36 includes a downlink optical fiber 136D having an input end 138 and an output end 140, and an uplink optical fiber 136U having an input end 142 and an output end 144. The downlink and uplink optical fibers 136D and 136U optically couple converter pair 66 at RFID reader 20 to the converter pair at transponder 30. Specifically, downlink optical fiber input end 138 is optically coupled to E/O converter 60 of reader 20, while output end 140 is optically coupled to O/E converter 62 at transponder 30. Similarly, uplink optical fiber input end 142 is optically coupled to E/O converter 60 of transponder 30, while output end 144 is optically coupled to O/E converter 62 at RFID reader 20.

RFID system 10 also includes a power supply 160 that generates an electrical power signal 162. Power supply 160 is electrically coupled to RFID reader 20 for powering the power-consuming elements therein. In an example embodiment, an electrical power line 168 runs through RFID reader 20 to transponder 30 to power E/O converter 60, O/E converter 62, and (optionally) RF signal-directing element 106, as well as other power-consuming elements (not shown) located therein. In an example embodiment, electrical power line 168 includes two wires 170 and 172 that carry a single voltage and that are electrically coupled to a DC/DC power converter 180 at transponder 30. DC/DC power converter 180 is electrically coupled to E/O converter 60 and O/E converter 62, and changes the voltage of electrical power signal 162 to the power voltages and level(s) required by the power-consuming components in transponder 30. In an example embodiment, electrical power line 168 includes standard electrical-power-carrying electrical wire(s), e.g., 18-26 AWG (American Wire Gauge) used in standard telecommunications applications. In another example embodiment, electrical power line 168 (dashed line) runs directly from power supply 160 to transponder 30 rather than from or through RFID reader 20. In another example embodiment, electrical power line 168 includes more than two wires that carry multiple voltages.

Also shown in FIG. 1 and FIG. 2 is a RFID tag 200 located within picocell 40. RFID tag 200 includes a microchip 204 electrically connected to an antenna 210 (FIG. 2). RFID tag 200 may be any of the standard types of RFID tags described above. RFID tag 200 is shown attached to an item 220.

### Method of Operation

With reference to the optical-fiber-based RFID system 10 of FIG. 1 and FIG. 2, in operation Digital signal processor 72 in controller 70 generates a downlink digital RF signal S1. This signal is received and modulated by RF signal modulator 46 onto an RF carrier generated by a carrier-generation unit (not shown). This creates electrical RF interrogation signal SI designed to activate or otherwise elicit a response from RFID tag 200.

Electrical RF interrogation signal SI is received by E/O converter 60, which converts this electrical signal into a corresponding optical signal SI′, which is then coupled into downlink optical fiber 136D at input end 138. It is noted here that in an example embodiment optical RF interrogation signal SI′ is tailored to have a given modulation index. Further, in an example embodiment the modulation power of E/O converter 60 is controlled (e.g., by one or more gain-control amplifiers, not shown) in order to vary the transmission power from antenna 100, which is the main parameter that dictates the size of the associated picocell 40. In an example embodiment, the amount of power provided to antenna 34 is varied to define the size of the associated picocell 40, which in example embodiments range anywhere from about a meter to about twenty meters across.

Optical RF interrogation signal SI′ travels over downlink optical fiber 136 to output end 140, where it is received by O/E converter 62 in transponder 30. O/E converter 62 converts optical RF interrogation signal SI′ back into electrical RF interrogation signal SI, which then travels to signal-directing element 106. Signal-directing element 106 then directs electrical RF interrogation signal SI to antenna 100. Electrical RF interrogation signal SI is fed to antenna 100, causing it to radiate corresponding electromagnetic RF interrogation signal SI″. Because RFID tag 200 is within picocell 40, electromagnetic RF interrogation signal SI″ is received by antenna 210 of the RFID tag. Antenna 210 converts electromagnetic RF interrogation signal SI″ into electrical RF interrogation signal SI (not shown in RFID tag 200), which is then received by microchip 204. In an example embodiment, microchip 204 is “awakened” by the electrical RF interrogation signal so generated, and in response thereto generates an electrical RF tag signal ST (not shown in the RFID tag), which is converted into an electromagnetic RF tag signal ST″ by antenna 210. In an example embodiment, electrical RF tag signal ST includes information about item 220 to which RFID tag 200 is affixed, such the item's identification, present location, last location, date displayed, actual age, etc. In an example embodiment, information about item 220 is written to RFID tag 200, as described below.

In an example embodiment, some or all of the one or more RFID tags 200 within the range of antenna 34 require activation by an interrogation signal. In a passive RFID tag 200, for example, the power in the electrical RFID interrogation signal SI formed within the RFID tag energizes microchip 204 with enough power to transmit the information stored in the RFID tag memory portion (not shown) of the microchip.

Because RFID tag 200 is located within picocell 40, electromagnetic RF tag signal ST″ is detected by transponder antenna 100, which converts this signal into electrical RF tag signal ST. Electrical RF tag signal ST is directed by signal-directing element 106 to E/O converter 60, which converts the electrical signal into a corresponding optical RF tag signal ST′, which is then coupled into input end 142 of uplink optical fiber 136U. Optical RF tag signal ST′ travels over uplink optical fiber 136U to output end 144, where it is received by O/E converter 62 at RFID reader 20. O/E converter 62 converts optical RF tag signal ST′ back into electrical RF tag signal ST, which is then demodulated by RF signal demodulator 48 to form uplink Digital signal S2. This signal is then processed by Digital signal processor 72 in controller 70. Controller 70 thus extracts the RFID tag information from electrical RF tag signal ST and stores the information in memory unit 76 and/or in external data storage unit 82. In an example embodiment, the RFID tag information is passed along to outside network 84 via network link 86.

### II. Centralized RFID System with Multiple RFID Readers

FIG. 4 is a schematic diagram of an example embodiment of an optical-fiber-based RFID system 300 according to the present invention. RFID system 300 has a central control station 310 that includes a plurality of RFID readers 20 (six are shown for the sake of illustration). Each of the RFID readers 20 is electrically coupled to a controller 320 that controls the operation of the RFID readers as well as the operation of RFID system 300 as a whole. In an example embodiment, a single power supply 160 is electrically coupled to central control station 310 and in particular to controller 320 and RFID readers 20.

In an example embodiment, RFID system 300 is operably coupled to a database storage unit 82 (e.g., via controller 320) for storing information transmitted by RFID readers 20. Also in an example embodiment, controller 320 is coupled to outside network 84 via network link 86.

Each RFID reader 20 is optically coupled to its corresponding transponder 30 via its optical fiber RF communication link 36. In an example embodiment, transponders 30 are arranged spaced apart in an optical fiber cable 340 that includes a downlink optical fiber 136D and an uplink optical fiber 136U for each optical fiber RF communication link 36. In an example embodiment, optical fiber cable 340 includes a protective outer jacket 344.

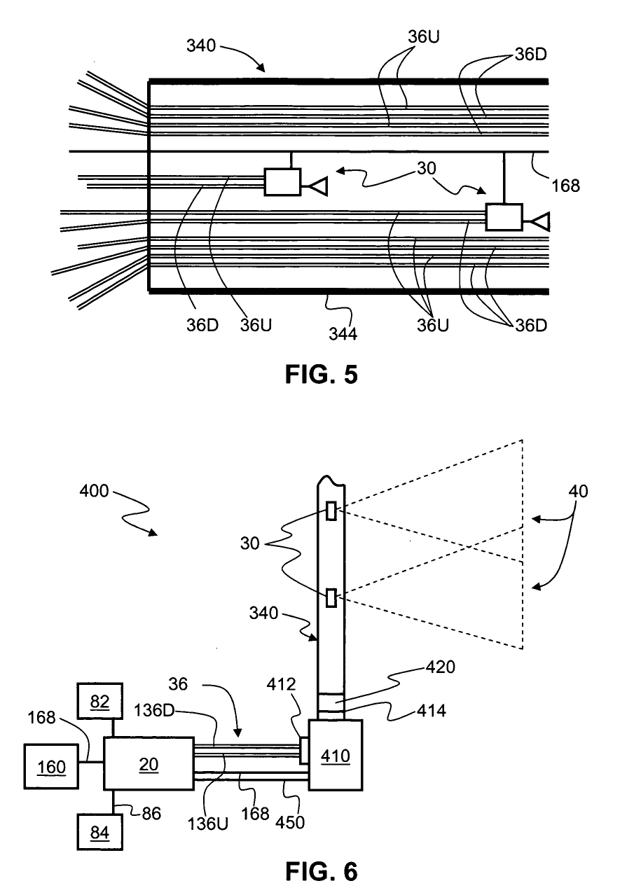

FIG. 5 is a close-up lengthwise cross-sectional view of a section of optical fiber cable 340 of FIG. 4, showing the individual downlink and uplink optical fibers 136D and 136U, along with electrical power line 168 and transponders 30.

### Method of Operation

With reference to FIG. 4 and FIG. 5, in the operation of RFID system 300, controller 320 activates one, some, or all of RFID readers 20 via an appropriate number of activation signals SA. In an example embodiment, some or all of RFID readers 20 are activated in series, while in another example embodiment some or all of the RFID readers are activated in parallel. Changing which RFID readers 20 are activated changes the extent and/or shape of picocell coverage area 44. The activated RFID readers 20 each generate an electrical RF interrogation signal SI and communicate this signal to their corresponding transponders via the corresponding optical fiber RF communication link 36, as discussed above in connection with RFID system 10. The addressed transponders 30 then generate corresponding electromagnetic RF interrogation signals SI″ within their associated picocell 40. RFID tags 200 located in one of picocells 40 (i.e., within picocell coverage area 44) will respond to the electromagnetic interrogation signal SI″ for that picocell and generate an electromagnetic RF tag signal ST″. Electrical RF tag signal ST is communicated to the corresponding RF reader 20 over the corresponding uplink optical fiber 136U, as described above. The corresponding RFID reader 20 process the (electrical) RF tag signal ST and sends it (or a processed version of it) to controller 320. Controller 320 then further processes the signal and stores the information, or stores the RFID information in external database storage unit 82. Alternatively, controller 320 may also pass along the RF tag signal ST or the information contained therein to outside network 84 via network link 86.

Note that in an example embodiment, a single electrical power line 168 from power supply 168 at central control station 310 is incorporated into optical fiber cable 340 and is adapted to power each transponder 30, as shown in FIG. 5. Each transponder 30 taps off the needed amount of power, e.g., via DC/DC converter 180 (FIG. 2). Since in an example embodiment the transponder functionality and power consumption is relatively low, only relatively low electrical power levels are required (e.g., ˜1 watt), allowing high-gauge wires to be used (e.g., 20 AWG or higher) for electrical power line 168. In an example embodiment that uses many transponders 30 (e.g., more than 12) in optical cable 340, or if the power consumption for transponders 30 is significantly larger than 1 watt due to their particular design, lower gauge wires or multiple wires are employed in electrical power line 168. The inevitable voltage drop along electrical power line 168 within cable 340 typically requires large-range (˜30 volts) voltage regulation at each transponder 30. In an example embodiment, DC/DC power converters 180 at each transponder 30 perform this voltage regulation function. If the expected voltage drop is known, then in an example embodiment controller 320 carries out the voltage regulation. In an alternative embodiment, remote voltage sensing at each transponder 30 is used, but is approach is not the preferred one because it adds complexity to the system.

### III. Centralized RFID System with a Single RFID Reader

Generally, the wireless RFID process of the present invention is relatively slow as compared to other wireless-based applications. The RFID process typically exchanges relatively few bits of information (e.g., about 100 bits to about 1 kilobyte) between each RFID tag 200 and RFID reader unit 20. Further, RFID communication in most cases is not time critical. In such instances, a single RFID reader 20 is used that communicates with each picocell 40 one at a time. In a typical RFID application of the present invention, transponders 30 are addressed once every second to once every minute, though other polling speeds can be implemented depending on the particular RFID application. In an example embodiment, sequential activation of transponders 30 is carried out at speeds much faster than the sampling rate needed to track the movement of RFID tags through picocells 40 for the particular RFID application. Such fast sampling provides substantially the same RFID data tracking as simultaneously addressing the transponders.

### III(a). Centralized RFID System with Optical Switch

FIG. 6 is a schematic diagram of an example embodiment of an optical-fiber-based RFID system 400 according to the present invention that utilizes a single RFID reader 20 and one or more transponders 30 in optical fiber cable 340. RFID system 400 includes an optical switch 410 having input/output (I/O) ports 412 and 414. Optical switch 410 is optically coupled to downlink and uplink optical fibers 136D and 136U at I/O port 412, and is optically coupled to optical cable 340 at I/O port 414. In an example embodiment, optical cable 340 includes an optical fiber cable connector 420 compatible with I/O port 414. An example connector 420 is an MT (“Mechanical Transfer”) connector, such as the UNICAM® MTP connector available from Corning Cable Systems, Inc., Hickory, N.C. In an example embodiment, connector 420 is adapted to accommodate electrical power cable 168, which passes through optical switch 410 and which powers the power-consuming elements in the optical switch.

Optical switch 410 can be any one of a number of types of optical switches capable of optically coupling one optical fiber to any one of a number of other fibers in an array or bundle of optical fibers. Optical switch 410 optically couples downlink and uplink optical fibers 136D and 136U at I/O port 412 to select ones of the downlink and uplink optical fibers coupled to I/O port 414.

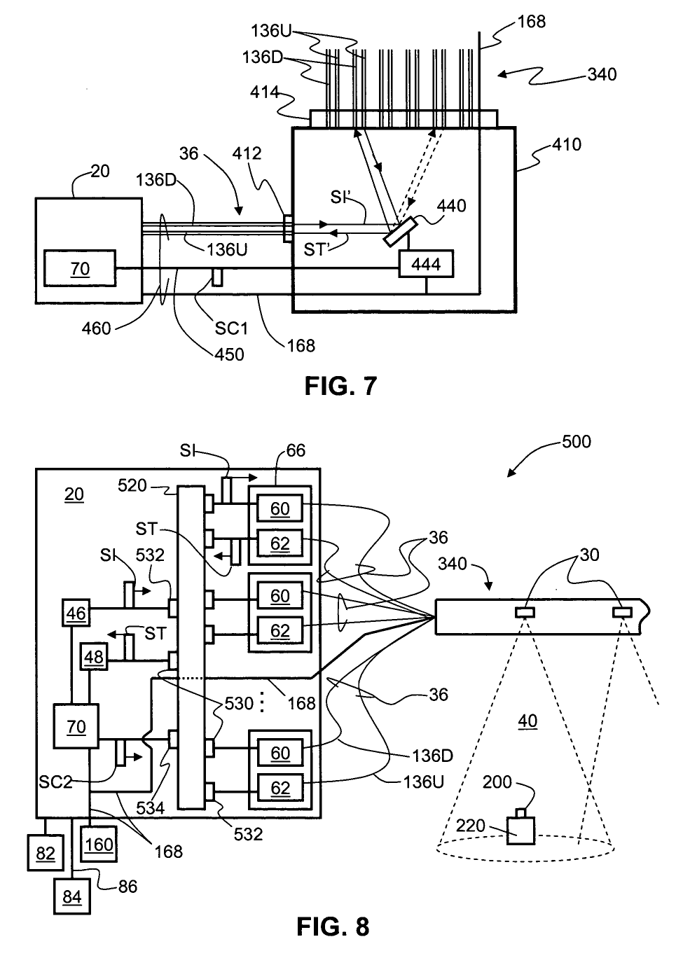

FIG. 7 is a close-up view of an example optical switch 410, showing the various downlink and uplink optical fibers 136D and 136U at the two I/O ports 412 and 414. Optical switch 410 includes an adjustable mirror device 440, such as a rotatable concave mirror, or a digital mirror device (DMD) mirror. Adjustable mirror device 440 is operably coupled to a mirror controller 444, which is operably coupled to RFID reader controller 70 via a controller link 450. Electrical power line 168 is electrically coupled to mirror controller 444 and provides power to the mirror controller as well as to the adjustable mirror device in the case where the adjustable mirror consumes power. In an example embodiment, controller link 450, optical fiber RF communication link 36 and electrical power line 168 are included in or otherwise constitute a single cable 460.

### Method of Operation

Adjustable mirror device 440 is arranged to receive optical RF interrogation signal SI′ (shown schematically in FIG. 7 as a light ray) from downlink optical fiber 36D at I/O port 412 and relay this optical signal to a select one of the downlink optical fibers 136D at I/O port 414. Likewise, adjustable mirror device 440 also receives optical RF tag signal ST′ from the corresponding uplink optical fiber 136U at I/O port 414 and relays this signal to a select one of uplink optical fibers 136U at I/O port 412.

In an example embodiment of system 400, controller 70 in RFID reader 20 is adapted (e.g., programmed) to adjust adjustable mirror 440 to optically couple the downlink and uplink optical fibers 136D and 136U at I/O port 412 to select uplink/downlink optical fibers at I/O port 414 via a control signal SC1 sent to mirror controller 444 over controller link 450.

### III(b.) Centralized RFID System with Electrical RF Switch

FIG. 8 is a schematic diagram of an example embodiment of an optical-fiber-based RFID system 500 according to the present invention that utilizes a single RFID reader 20 and a plurality of transponders 30 in optical fiber cable 340. In RFID system 500, RFID reader 20 includes a number converter pairs 66, one for each transponder 30 in optical fiber cable 340. Each converter pair 66 is optically coupled to a corresponding optical fiber RF communication link 36, with the downlink optical fiber 136D optically coupled to E/O converter 60 and the uplink optical fiber 136U optically coupled to the O/E converter 62. RFID system 500 includes a RF switch 520 having output ports 530 and input ports 532. E/O converters 60 are electrically coupled to output ports 530, while O/E converters 62 are electrically coupled to input ports 532. RF signal modulator 46 is electrically coupled to RF switch 520 at an input port 530, while RF signal demodulator 48 is electrically coupled to the RF switch at an output port 530. Controller 70 is electrically coupled to RF switch 520 at a controller port 534.

### Method of Operation

In the operation of RFID system 500, electrical RF interrogation signal SI is generated at RFID reader 20 as described above, and is directed to RF switch 520. RF switch 520 receives electrical RF interrogation signal SI and directs it to one of converter pairs 66 as determined by the setting of the RF switch, which is controlled by controller 70 via a control signal SC2 provided to the RF switch at controller port 534. Thus, RF switch 520 allows for each transponder 30 in optical fiber cable 340 to be individually addressed using a single RF reader 20 in a manner similar to that of RFID system 10 of FIG. 2.

In an example embodiment, RF switch 520 is adapted to form multiple electrical RF interrogation signals SI from each inputted signal SI, and send each signal SI to corresponding multiple converter pairs 66. This allows RF reader 20 to address some or all of transponders 30 at the same time. In this example embodiment, RF switch 520 preferably includes amplifiers (not shown) to boost the signal strength of the divided interrogation signal. Likewise, RF switch 520 is adapted to receive at input ports 532 the RFID tag signals ST from the various RFID tags 200 within picocell coverage area 400 and direct them to the output port 530 to which controller 70 is electrically coupled. RFID tag signals ST are then processed by RFID reader 20 as described above.

### IV. RFID System with Multiple RFID Readers and Multiple Optical Fiber Cables

In an example embodiment wherein RFID communication between transponders 30 with a single RFID reader 20 would be too slow or otherwise inadequate, the present invention includes an embodiment of an optical-fiber-based RFID system having two or more RFID readers. Multiple RFID readers 20 might be used, for example, when there is a need to inventory a large number of RFID tags 200 (e.g., thousands or many thousands) in a given picocell coverage area 44.

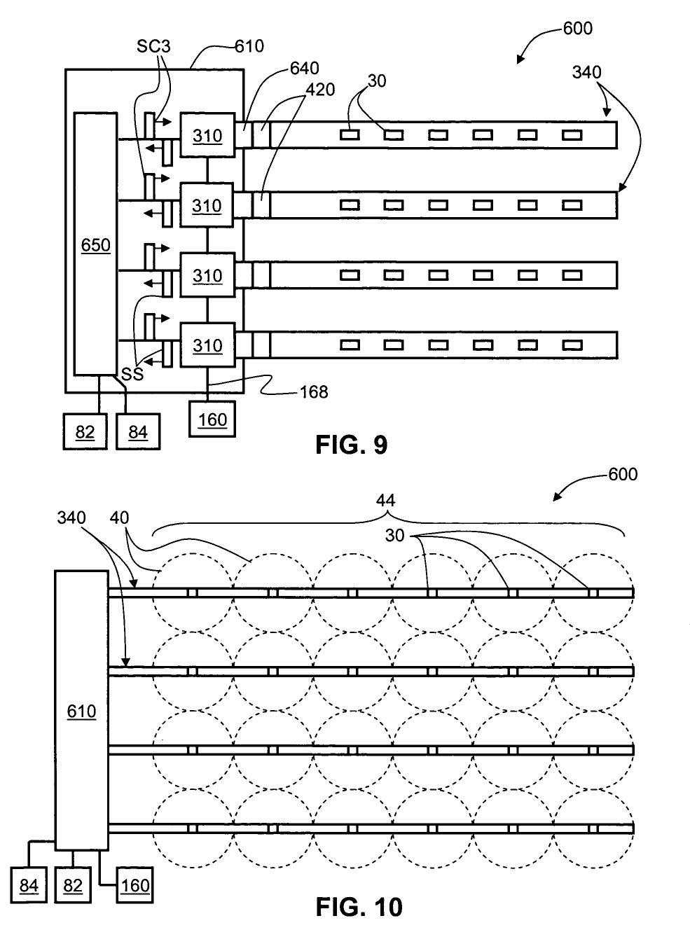

FIG. 9 is a schematic diagram of an example embodiment of an optical-fiber-based-RFID system 600 according to the present invention. RFID system 600 includes multiple optical fiber cables 340 each connected to a corresponding central control station 310, as in RFID system 300 of FIG. 3. In the present example embodiment, central control stations 310 are referred to simply as “control stations.” Control stations 310 constitute a larger main control station 610. Main control station 610 includes a central controller 650 that is operably coupled to each controller 320 of each control station 310 (FIG. 4). Central controller 650 is adapted to control and coordinate the operation of control stations 310.

Power supply 160 is electrically coupled to main control station 610 and provides power thereto. Optionally coupled to main control station 610 is external database storage unit 82 and outside network 84 via network link 86. In an example embodiment, each optical fiber cable 340 has connectors 420, and main control station 610 has corresponding connectors 640 that operably connect with the connectors 420.

### Method of Operation

With continuing reference to FIG. 9 and also to FIG. 4, in the operation of RFID system 600 central controller 650 sends control signals SC3 to one, some or all of control stations 310. Control signals SC3 cause controllers 320 in the corresponding control station 310 to address their corresponding transponders 30 in the corresponding optical fiber cable 340. Each control station 310 then operates as described above to collect information from RFID tags 200 within the corresponding picocells 40. RFID tag information from each control station 310 is provided to central controller 650 via control station signals SS from each controller 320 in each control station. Central controller 650 can either internally store the information contained in control station signals SS, store the information in external data storage unit 82, or pass the information to network 84 via network link 86.

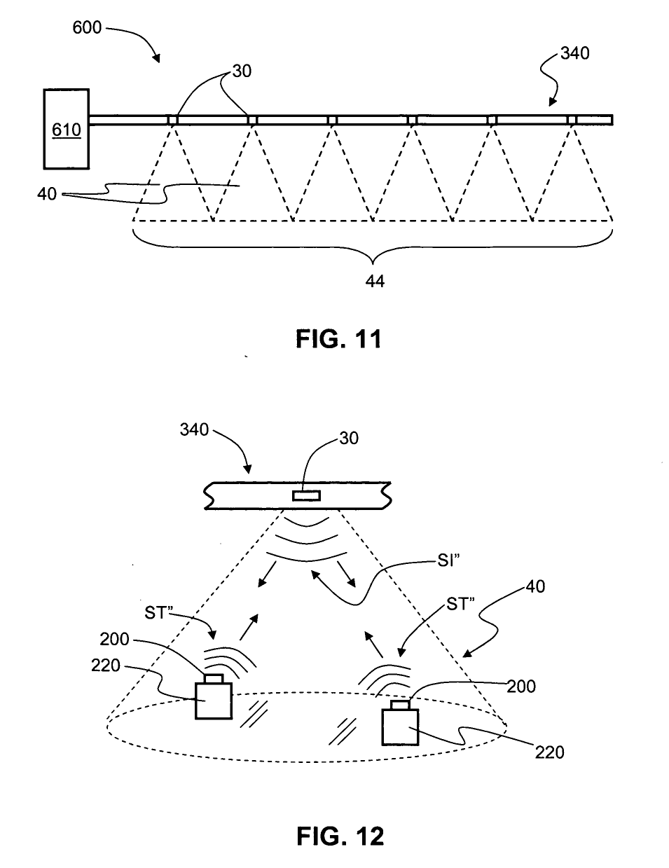

FIG. 10 is a schematic “top-down view” of RFID system 600 of FIG. 9, illustrating the extended picocell coverage area 44 offered by using multiple optical fiber cables 340. FIG. 11 is a schematic diagram of a “side-view” of picocell coverage area 44 of FIG. 10. FIG. 12 is a close-up view of a single transponder 30 and the corresponding picocell 40, illustrating the interrogation of RFID tags 200 within the picocell, and the response elicited from the RFID tags, as described above. Note that if multiple RFID tags 200 are located in a given picocell 40, in an example embodiment the corresponding RFID reader 20 reads one RFID tag at a time. This involves, for example, sending an electromagnetic RFID interrogation signal SI″ out to all RFID tags 200, with a tag number starting with a certain bit. If more than one RFID tag 200 responds, then RFID reader 20 uses the next bit in the RFID tag number to distinguish between the multiple RFID tags until just one RFID tag responds. The other RFID tags 200 within the picocell are read at different times based upon their particular RFID tag numbers.

### V. Advantages and Applications

### Centralized Upgrades and Updating

The centralized optical-fiber-based RFID system of the present invention is very flexible and has a number of advantages over conventional RFID systems. For example, RFID system upgrades (e.g., new hardware) are simple to perform since they can be done at a central location. In an example embodiment of the present invention, the RFID reader(s) is/are used for RFID tag writing to add or update information in RFID tags 200. This is accomplished, for example, by sending update signals SU in place of interrogation signals SI. RF signal modulator 46, in response to signals S3 from Digital signal processor 72 in controller 70, generates update signals SU (FIG. 2) that are communicated to one, some or all of RFID tags 200 in the same manner that interrogation signal SI is communicated. Such RFID tag writing allows changing item assignments, e.g., to different work groups, projects, or the item status (e.g., from “on sale” to “sold”, a change in price, etc.).

### Resolution and RFID Tag Tracking

In an example embodiment, the optical-fiber-based RFID system of the present invention polls RFID tags 200 within the picocellular coverage area 44. The information obtained can be stored in external data storage unit 82, in the local controller (e.g., in memory unit 76 of controller 70 of RFID system 10 of FIG. 2), or be passed onto external network 84. Because picocells 40 are relatively small, the RFID system knows the locations of all RFID tags 200 within picocellular coverage area 44 to a very high spatial resolution, e.g., a few meters, and can track movement of the RFID tags as they move between picocells.

The optical-fiber-based RFID systems of the present invention are capable of tracking a very large number of RFID tags 200 particularly in the case where the various controllers (namely, controllers 70, 320, 650) have modern computer processing capability. In an example embodiment, the present invention includes computer-based position and/or movement tracking of items 220. In an example application of the RFID systems of the present invention, optical fibers 340 are arranged relative to shelves in a warehouse in order to create picocell coverage areas to track and inventory RFID-tagged and shelved items. In this regard, the RFID systems of the present invention have particular applicability to remote warehouse inventory management for a variety of different industries, services and products.

### Introducing New RFID Tags into the Picocellular Coverage Area

In certain applications of the optical-fiber-based RFID system of the present invention, one or more of the RFID readers will discover new RFID tags 200 that enter picocellular coverage area 44 between interrogation signals SI. In an example embodiment, if a RFID tag 200 is destroyed, the RFID system is adapted (e.g., programmed) to generate an alarm, and provide the last position (or complete tracking history) of the item, e.g., based on data stored in data storage unit 82 or in a controller's memory unit, e.g., memory unit 76 in controller 70 (FIG. 2).

### Overlapping Picocells

In practice, picocells 40 generally do not have sharp boundaries (such as shown in FIG. 10) but overlap with adjacent picocells (such as shown in FIG. 4). Consequently, it can happen that more than one picocell 40 covers and reads the same RFID tag 200. In this case, the RFID system can precisely identify the location of the corresponding item 220. If two or more picocells 40 read a RF tag 200, the RFID tag must be located at the crossing points between the picocells. In an example embodiment, the RFID system is adapted (e.g., programmed) to account for picocell overlap and determine the position of the RFID tag.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. An optical-fiber-based radio-frequency identification (RFID) system for tracking one or more RFID tags each having information stored therein, comprising:
a picocellular coverage area made up of an array of one or more picocells formed by corresponding one or more transponders each having an antenna and each adapted to convert electrical RF signals to optical RF signals and vice versa;
one or multiple RFID readers each optically coupled to the one or more transponders via corresponding one or more optical fiber RF communication links; and
wherein each transponder is optically coupled to one of the one or multiple RFID readers and is adapted to receive and relay information stored in each RFID tag located within the corresponding picocell to the corresponding RFID reader over the corresponding optical fiber RF communication link.

2. The system of claim 1, wherein each the optical fiber RF communication link includes a downlink optical fiber and an uplink optical fiber.

3. The system of claim 2, wherein the one or more transponders are arranged in an optical fiber cable formed from the uplink and downlink optical fibers.

4. The system of claim 3, wherein the one or more transponders are arranged in multiple optical fiber cables each optically coupled to at least one RFID reader.

5. The system of claim 3, wherein the optical fiber cable includes a plurality of spaced-apart transponders.

6. The system of claim 1, including multiple RFID readers located at a central control station.

7. The system of claim 1, where the system includes:
an optical switch;
a single RFID reader, wherein the single RFID reader is optically coupled to the optical switch via a first optical fiber RF communication link;
a plurality of transponders optically coupled to optical switch via a plurality of second optical fiber RF communication links; and
wherein the optical switch is adapted to switch optical coupling between the first optical fiber RF communication link and each of the second optical fiber RF communication links so as to allow for the RFID reader to communicate with one transponder at a time.

8. The system of claim 1, having a single RFID reader and a plurality of transponders optically coupled thereto via a corresponding plurality of communication links, and wherein the single RFID reader includes:
a plurality of converter pairs each comprising an electrical-to-optical (E/O) converter and an optical-to-electrical (O/E) converter, with each converter pair optically coupled to one of the transponders via one of the optical fiber RF communication links; and
a RF switch that directs electrical RF signals to and from different converter pairs in order to communicate with one transponder at a time.

9. An optical-fiber-based radio-frequency identification (RFID) system for tracking one or more RFID tags that emit electromagnetic RFID tag signals, comprising:
one or more RFID readers;
one or more transponders each adapted to convert optical RF signals to electromagnetic RF signals and vice versa over a picocell formed by the corresponding transponder;
one or more optical fiber RF communication links that optically couple each of the one or more transponders to the one or more RFID readers; and
wherein the one or more RFID readers send RF interrogation signals to one or more transponders over the one or more optical fiber RF communication links to cause the one or more transponders to electromagnetically interrogate RFID tags within a given picocell, and relay RFID tag information emitted by the RFID tags over the optical communication link back to the corresponding RFID reader.

10. The system of claim 9, having a plurality of transponders and a single RFID reader that includes a RF switch electrically coupled to each of a plurality of pairs of electrical-to-optical (E/O) converters and optical-to-electrical (O/E) converters so as to allow the single RFID reader unit to communicate with one transponder at a time.

11. The system of claim 9, having a single RFID reader and a plurality of transponders, wherein the single RFID reader and the plurality of transponders are optically coupled to an optical switch adapted to allow the single RFID reader to optically communicate with one transponder at a time.

12. The system of claim 9, wherein the one or more transponders is/are arranged along an optical fiber cable that includes the one or more optical fiber RF communication links.

13. The system of claim 9, wherein the one or more RFID tags are affixed to corresponding one or more items.

14. A radio-frequency identification (RFID) method, comprising:
locating one or more RFID tags having information stored therein within a picocellular coverage area made up of one or more picocells formed by corresponding one or more transponders;
sending an interrogation signal from a RFID reader to each transponder over a corresponding optical fiber in order to elicit RFID tag signals from any RFID tags located in the corresponding transponder picocell;
detecting in the corresponding transponder electromagnetic RFID tag signals emitted within each picocell by RFID tags therein; and
transmitting the received RFID tag signals to the corresponding RFID tag reader over an optical fiber.

15. The method of claim 14, including optically coupling the one or more transponders to the same RFID reader.

16. The method of claim 15, including arranging a plurality of transponders spaced apart along an optical fiber cable.

17. The method of claim 16, including employing a plurality of the optical fiber cables to create a picocellular coverage area.

18. The method of claim 14, including employing a plurality of RFID readers at a central control station.

19. The method of claim 14, including using either an optical switch or an RF switch to switch between a single RFID reader and a plurality of transponders optically coupled to the RFID reader.

20. The method of claim 15, including writing information from at least one RFID reader to at least one of the one or more RFID tags.
